(19) United States
(12) Patent Application Publication
(10) Pub. No.: US 2019/0216687 A1
(43) Pub. Date: Jul. 18, 2019

(54) LIP AND NIPPLE ASSEMBLY

(71) Applicant: Jennifer Dajas, Concord, CA (US)

(72) Inventor: Jennifer Dajas, Concord, CA (US)

(21) Appl. No.: 16/221,251

(22) Filed: Dec. 14, 2018

Related U.S. Application Data
(60) Provisional application No. 62/617,583, filed on Jan. 15, 2018.

(51) Int. Cl. A61J 11/04; A61J 11/00

(52) U.S. Cl. CPC A61J 11/04; A47G 19/2266; A61J 11/008; A61J 11/0035

(57) ABSTRACT

The present invention is a universal ‘replacement lid with nipple assembly’ that removably affixes, via threading, to inter alia thermally insulated bottles. The instant invention features a “replacement lid” with a cylindrical hole through the center. The [bottle's] “replacement lid” [and its corollary attachments, components and features] turn an ordinary bottle into a universal baby-bottle. Atop said hole (annular aperture), rests a ridged rim/lip, under which is positioned a plastic nipple (with optional lugs to further secure said nipple in place in the deployed position). A “sealing disc” and a half-eggshell-cap together prevent spillage when not in use. The nipple “clips in” under the lid ridged lip, and may be stored “upside down” when the bottle is not in use. This feature, combined with the novel feature of a “sealing disc,” allows for secure, leak-proof nipple storage. When “in use/deployed-position,” the nipple simply turns “right-side-up” and “clips in” to the [bottle] replacement lid [positioning itself just underneath the outer-circumference ridge-lip], allowing for normal dispensation of liquid to the baby. Alternate embodiments also function as a replacement-lid-nipple (with valved-spout) for toddlers' “sippy-cup” type devices, as described infra and supra. Also of note is that said invention is compatible with both aluminum bottles and also double-walled thermally insulated bottles.

### CROSS REFERENCE TO RELATED APPLICATIONS

This application claims priority to U.S. PROVISIONAL UTILITY PATENT APPLICATION 62/617,583 FILED Jan. 15, 2018.

### TECHNICAL FIELD

The overall field of the invention is baby feeding bottles, sealable, thermally insulated baby bottle assemblies and improvements in nursing nipples and cover lids therefor, which can be adapted and applied to a variety of thermally insulating bottles and containers.

### BACKGROUND

One prevalent dilemma for modern-day mothers and fathers regarding breast milk (and formula) storage and delivery is temperature maintenance. In short, the key issue is: “how to keep the breast milk (or formula) at the proper constant temperature while the parent is “in the field/on the go” ?

This dilemma is not physiologically or logistically insignificant. Gerber Baby Food Products of Nestle Global Inc., states (2016): “[t]he key to warming breast milk while preserving its full nutritional value is to avoid overheating. Your goal is to heat breast milk to approximately at or a bit below body temperature (98.6 F/37 C).”

The Mayo Foundation for Medical Education and Research (MFMER) (2018) states: “[f]reshly expressed breast milk can be stored in an insulated cooler with ice packs for up to one day. Freshly expressed breast milk can be stored in the back of a refrigerator for up to five days in clean conditions. Freshly expressed breast milk can be kept at room temperature for up to six hours. However, use or proper storage within four hours is optimal. If the room is especially warm, the limit is also four hours. Freshly expressed breast milk can be stored in an insulated cooler with ice packs for up to one day.”

The problem is no simpler for formula. WebMD LLC (2015) states: “[i]t's fine to give your baby room temperature or even cold formula. If your baby prefers warm formula place a filled bottle in a bowl of warm water and let it stand for a few minutes—or warm the bottle under running water. The formula should feel lukewarm—not hot. Don't warm bottles in the microwave. Opened formula, either ready-to-feed or liquid concentrate, shouldn't be left at room temperature longer than two hours—and no more than an hour if the room is warm. Formula directions read “refrigerate for 24 hours, then let sit out for one to two hours.

Other Formula products recommend maximum external exposure for “no more than one hour.” (World Health Organization, 2007).

What is needed, therefore, is a transportable, vacuum-insulated, substantially airtight baby bottle with a sealable travel-nipple, or an attachment assembly, specially designed to transform a common thermally insulated bottle into an insulated baby bottle.

### SUMMARY OF THE INVENTION

The present invention is an a universal nipple assembly that removably affixes, via threading, to (e.g.) Hydro Flask™ and Yeti™ [and other, infra] thermally-insulated bottles. The instant invention features a “replacement lid” with a cylindrical hole through the center. This [bottle's]replacement lid [and its corollary attachments, components and features] is the crux of the invention. Atop said hole (annular aperture), rests a ridged rim lip, under which is positioned the plastic nipple.

In this fashion, the nipple “clips in” and may be stored “upside down” when the bottle is not in use. This feature, combined with the novel feature of a “sealing disc,” allows for secure, leak-proof nipple storage. When “in use,” the nipple simply turns “rightside-up” and “clips in” to the [bottle]replacement lid [positioning itself just underneath the outer-circumference ridge-lip], allowing for normal dispensation of liquid to the baby.

Alternate embodiments also function as a replacement-lid-nipple (replacement valved-spout) for toddlers' “Sippy-Cups™” as described infra.

Also of note is that said invention is compatible with both aluminum bottles and also double-walled thermally insulated bottles.

### BRIEF DESCRIPTION OF DRAWINGS

FIG. 1 is an exploded front-side view showing [from bottom to top] the bottle, sealing disc, the threaded replacement lid with central annular cylindrical aperture, outer notches to accommodate the “snap on eggshell cap,” and [atop lid] recessed-central region with raised-ridged edge [lip] at outer circumference to accommodate the nipple skirt and sealing disc [when bottle is closed], and to accommodate nipple with skirt (without sealing disc) in right-side-up position for feeding (as shown).

FIG. 2 is an assembled sectional front-side view showing the bottle and nipple assembly in its closed-sealed position, featuring the replacement lid nipple assembly affixed to the bottle via threading, with sealing disc and nipple in their “down/fixed” position, and with the eggshell cap positioned (“snapped”) atop the bottle via lid ridges.

FIG. 3 is an alternative embodiment replacement lid featuring a handle affixed to the sides of the replacement lid via hinge.

FIG. 4 shows an alternate embodiment of eggshell cap with elongated self-sealing anchor loop for fixing to replacement lid's [alternate embodiment] handle.

FIG. 5 shows an alternate embodiment of eggshell cap without the elongated self-sealing anchor loop for fixing to replacement lid's [alternate embodiment] handle.

FIG. 6 shows the same alternate embodiment of eggshell cap with elongated self-sealing anchor loop for fixing to replacement lid's [alternate embodiment] handle.

FIG. 7 shows the replacement lid with central bore hole, optional handle, and threading as well as representation of the nipple attachment (nipple attachment herein shown in broken lines).

FIG. 8 shows an isometric view of an embodiment of the replacement lid.

FIG. 9 shows an isometric view of the nipple attachment piece, herein featuring the lugs.

FIG. 10 shows an isometric view of a bottle utilizing the replacement lid from FIG. 8 as well as the nipple from FIG. 9.

FIG. 11 shows an exploded side view of the FIG. 10 bottle showing the threading on the replacement lid and the nipple skirt position in relation to the replacement lid.

### DETAILED DESCRIPTION

Two of the most common thermos type (insulating) bottles in the industry are Hydro Flask™ and Yeti™ bottles. These bottles feature Vacuum Insulated Stainless Steel skin, Standard Mouth w/Optional Loop Lid, Double Wall Vacuum Insulated Stainless Steel Leak Proof Sports Bottle Models, Wide Mouth with BPA Free Flex Lids, customary (though not essential) Standard Mouth 1.81″ openings, double-wall vacuum insulated TempShield™ technology, non-toxic BPA-free plastics & 18/8 stainless steel food-grade stainless steel, offered in a variety of sizes, including (but not limited to) 18/26/36/64 oz. bottles. The herein-disclosed invention works with all the above models and specifications.

The instant invention is therefore designed to accommodate at least the aforementioned bottle styles and their associated models.

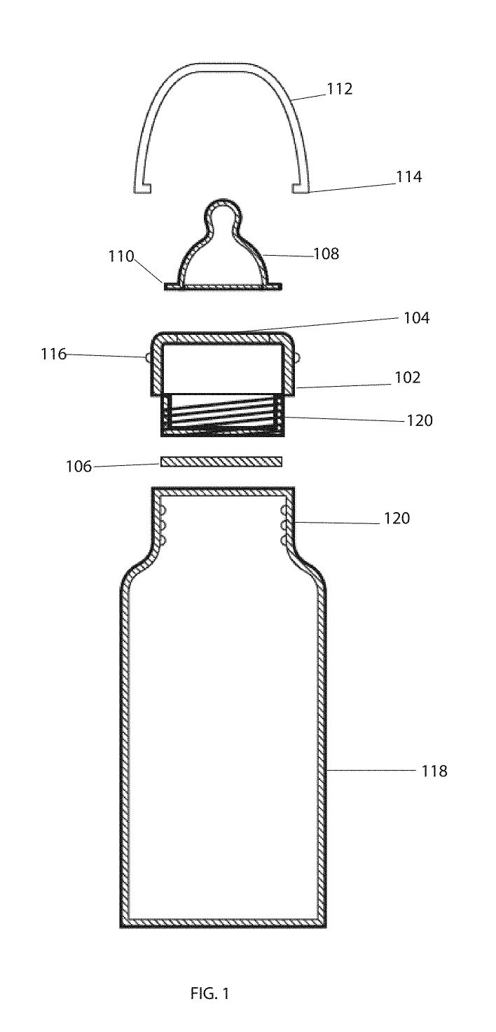

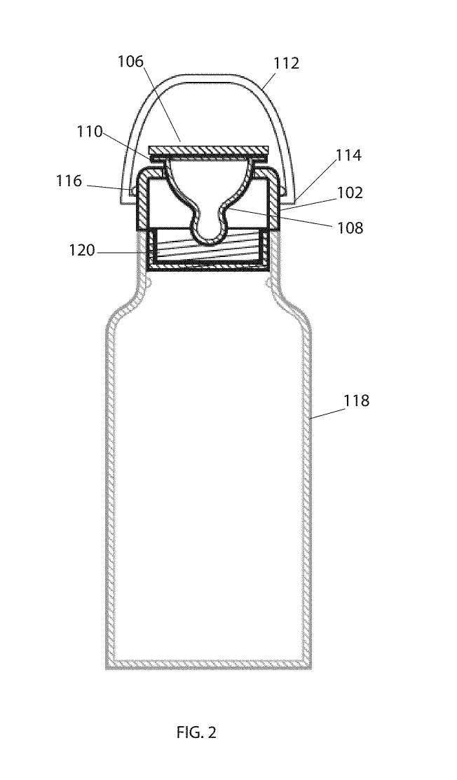

Referring to FIGS. 1 & 2, the NIPPLE ATTACHMENT ASSEMBLY comprises the instant “threaded replacement lid” 102 for the Hydro Flask™ and Yeti™ (and other) style thermally insulated bottles. Unlike the normal Hydro Flask™ or Yeti™ lid, in the instant invention, the center of the lid comprises an annular aperture (a cylindrical hole) 104 of diameter between about 39%-59% of the diameter of the lid's total diameter. The upper portion of the lid (hereinafter “replacement lid”), which houses the nipple in its “concealed” position (FIG. 2), comprises dimples to help the nipple (discussed infra remain fixed in place (once so positioned) The upper portion of said replacement lid has a recessed center in its upper portion 704, surrounded by a ridged lip 706 under which the sealing disc and nipple may be positioned.

This inwardly facing outermost-uppermost ridge 706 of the lip 704, of the replacement lid comprises the top-outer-circumference of the invention's replacement lid. The replacement lid [the hollow-centered cylindrical]replacement lid] 102 replaces the solid threaded lid of factory-model Hydro Flask™ and Yeti™ bottles. In this way, liquid may still pass through the bottle and through the nipple while the lid remains on, making the device convenient for mothers and fathers using the invention as a baby bottle.

The outer ridge functions as a lip, under which the nipple skirt 110 is positioned in the “nipple up” feeding” position, and it houses the nipple skirt 110 and the sealing disc 106 in the “nipple down” closed/traveling position.

This ridged lip 706/704 covers between around 5% to around 29% of the nipple skirt's 110 total area, thereby ensuring the skirt does not break free of the lip-ridge 704/706 in the feeding (nipple up) position without force greater than gravity+normal agitation force. Note: while the apparatus device is “nipple up” in the feeding position, the nipple itself will customarily be facing “down/toward-the-ground” during actual feeding, as the whole bottle will be canted toward the baby's mouth for the liquid to pour into the baby's mouth.

The uppermost feature of FIG. 2 is the “eggshell cap” 112 shown in profile, featuring [at its base] internal [inside circumference] notches 114 on the inner surface of the eggshell cap. The eggshell cap then “snaps” into its position around the exterior ridge-tabs 116 of the replacement lid piece 102.

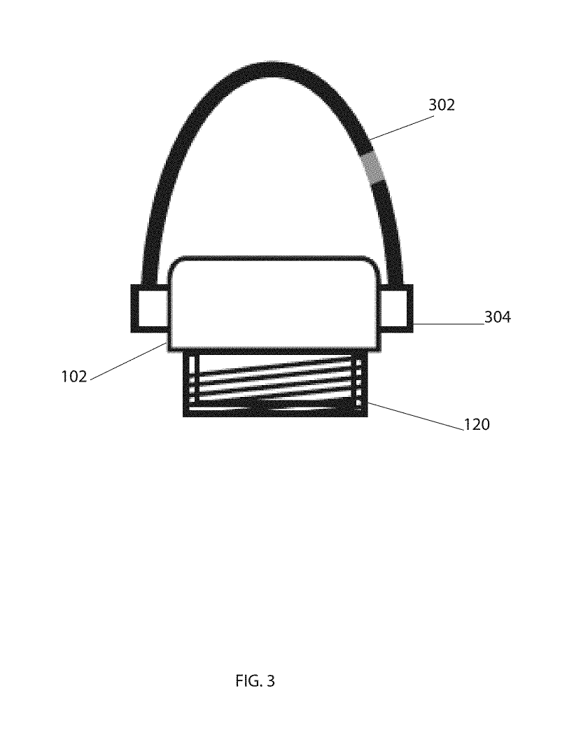

FIG. 3 shows the same alternate embodiment hinged 304 handle 302, with a spot for temporary placement of the removed (not shown) eggshell cap.

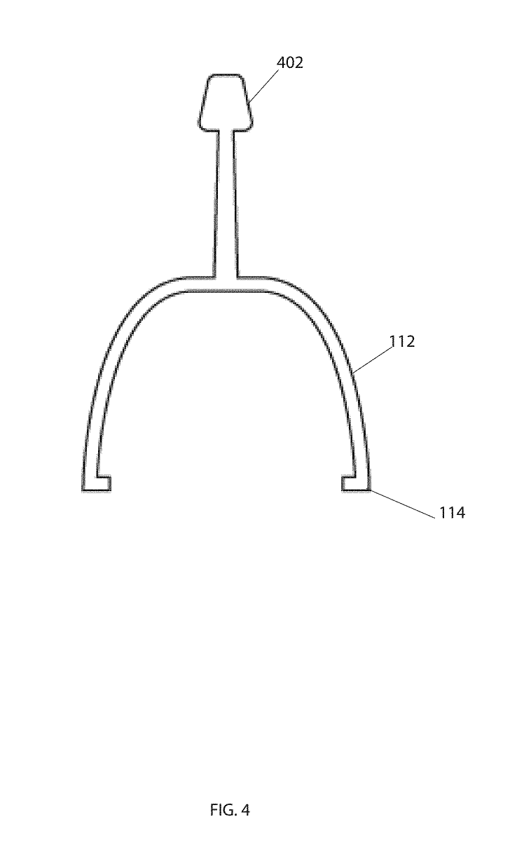

FIG. 4 shows the same [alternate embodiment] eggshell cap with elongated self-sealing anchor loop 402 for fixing to replacement lid's [alternate embodiment] handle.

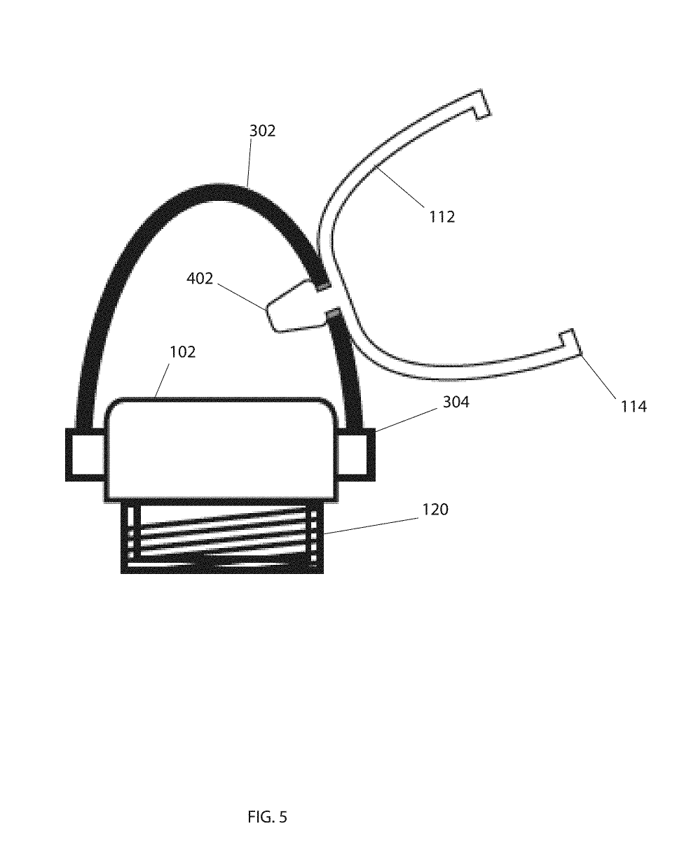

FIG. 5 shows an assembled view of the [alternate embodiment] self-fastening eggshell cap 112 in its fixed position, temporarily fastened to the replacement lid's [alternate] handle via “loop and eye” or “hammerhead anchor” fastener 402. In this way, the eggshell cap 112 further comprises a tethered hammerhead style anchor 402 which, when cap is removed, tethers around the replacement cap's hinged handle for temporary positioning until feeding is complete.

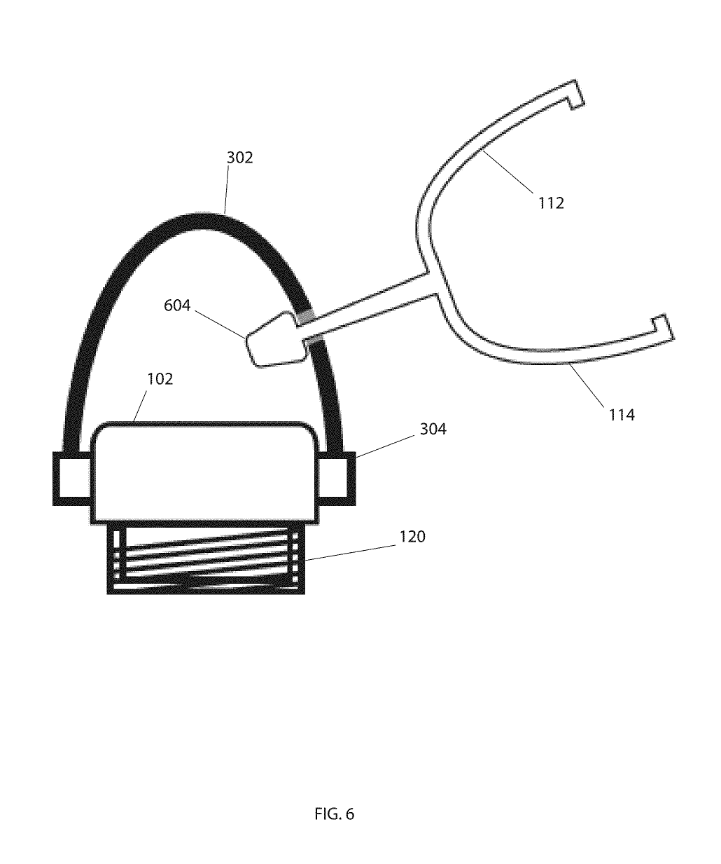

FIG. 6 shows the “plug and socket” 604 [alternate embodiment] fastening means of FIG. 3 in its “fastened/clipped-on” position, temporarily securing the eggshell cap 112 to the handle 302 until feeding is complete. In this alternate embodiment, the [alternate] hinged 304 strap 302 further comprises a standard coupler 604 (plug and socket latch) which is attached and removed with a “squeeze and push/pull” method.

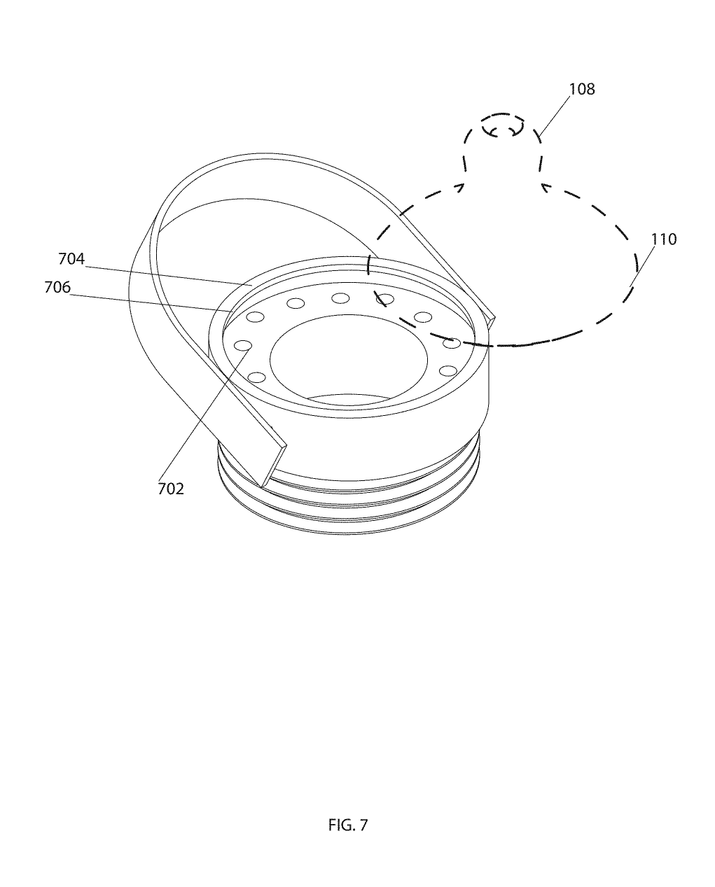

The central body of the replacement lid is hollow for receipt of a liquid through the top opening as shown in FIG. 7. The opening includes threads on the upper sidewall, which mate with the internal threads of the bottle's mouth.

The nipple is a conventional baby bottle nipple. Such nipple includes a flat base or flange adapted to the open upper end of the container (the outer-rimmed-lip 704/706 of the replacement lid 102) in the upstanding nursing position.

The housing of the bottle comprises, in the preferred embodiment, stainless steel or aluminum or amalgam thereof, while the inner container comprised of optically transparent thermoplastic chosen from the group consisting of polyethylene, polypropylene, PVC or polycarbonate. Said inner and outer containers are separated by a substantially airtight hollow space throughout, providing thermal insulation.

FIG. 7 is an isometric view that shows how liquid is able to travel through the replacement cap 102, as well as the position 704 where the nipple 110 is secured when positioned in its “deployed” position.

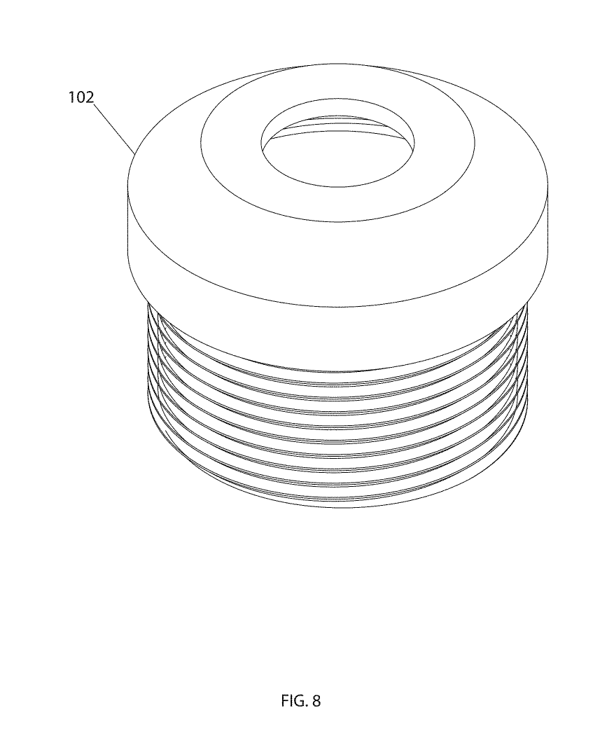

FIG. 8 depicts an isometric view of an embodiment for the replacement lid utilizing a smaller central hole and the exterior threading of the replacement cap 102.

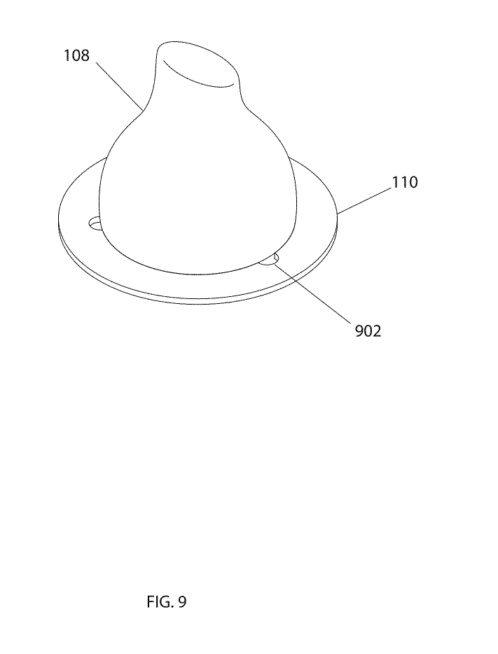

FIG. 9 shows the isometric view of the nipple attachment 108 and nipple skirt 110, as well as the nipple lugs 902 at the nipple skirt's base.

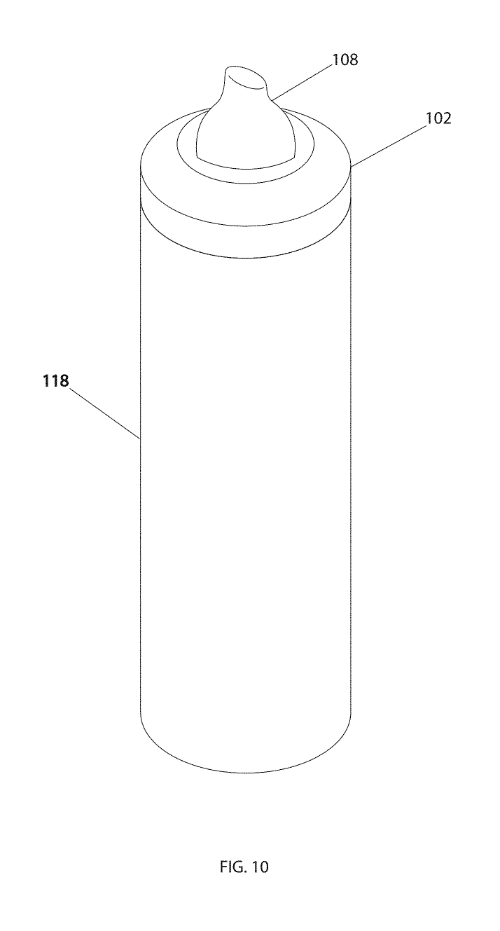

FIG. 10 shows an isometric view of the fully assembled bottle 118 with the nipple 108 and the replacement lid 102 in an engaged-deployed mode ready for drinking/suckling.

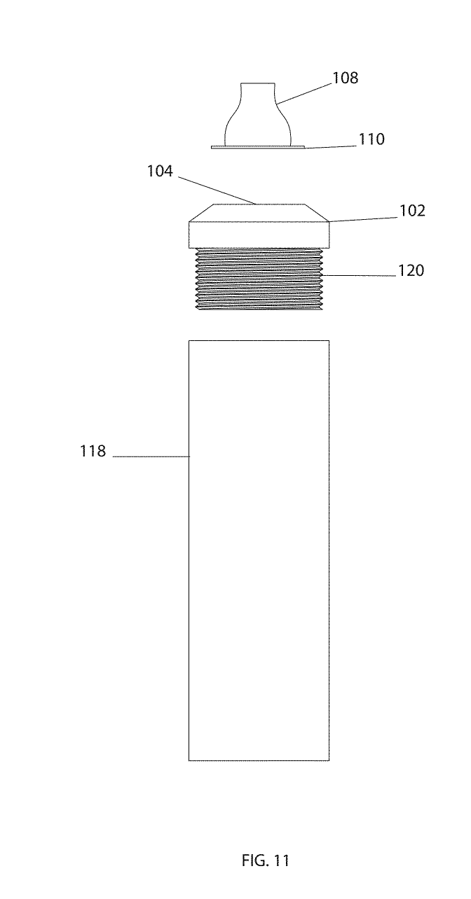

FIG. 11 depicts an exploded-side view showing the exterior threading 120 of the replacement lid 102 as well as depicting the relational positioning between the nipple 108 and the replacement lid 102, as well as the approximate length of nipple skirt 110 that will be hidden within the lip 704 of the lid 102 once inserted.

### Additional Specifications for Alternate Embodiments

For the YETI™ Bottle style thermos, featuring its threaded TRIPLEHAUL™ cap, featuring “THREE FINGER GRIP FOR EASY CARRY™, the instant invention's “[hollow] REPLACEMENT LID 102” is useful in the same ways as mentioned above (supra).

One additional feature of the instant invention is that it is compatible with both the YETI™ and the HYDRO FLASK™ model bottles, as well as other bottles, in that it also accommodates the customary (child's) “Sippy Cup” type training-spout (rather than customary nit2Qle}. The Sippy cup is a spill-proof drinking cup designed for toddlers. It works by way of surface tension that prevents liquid from being spilled even when the cup is upended.

Typical Specifications of said Sippy Cup Spout(s) include the Silicone spout, 10 oz; 12 m+, or 4.88″×3.50″×5.88,″ or other appropriate dimensions: the instant invention accommodates all these spouts and their spill-proof valve technologies.

The instant invention's Sealing Disc 106b continues to be positioned underneath the spout/nipple in both assembled embodiments (the Yeti™ embodiment family and the Hydro Flask™ embodiment family, as well as other similarly functioning models). Even if the Sippy Cup's spout skirt further comprises base lugs for additional traction, these lugs still fit under the ‘ridged lip 704’ of the invention's REPLACEMENT LID 102 and still rests above the SEALING DISC 106 of each embodiment in its assembled state.

The instant invention is compatible with the NUK™, PLAYTEX™, GERBER GRADUATES™, Chicco Natural Fit™, and other appropriate “Sippy Cup” style spouts and replacement valves. Whether the Sippy Cup has a “Naturalatch™ or Silicone or other plastic type spout (with or without skirt), the Sippy Cup Spout is entirely compatible with the above invention, installed and removed in the same method and placed/removed in the same component-positions as the aforementioned “replacement lid nipple” invention.

### Further Alternate Embodiments

The Instant Invention wherein nipple attachment further comprises a thermometric means for indicating temperature (thermometer).

The Instant Invention further comprising liquid crystals or other heat sensitive material, which turns color upon a threshold acidification (fermentation/culturing/souring) of the milk to visibly aid parents in recognizing expiration.

### Alternate Method of Describing the Herein-Disclosed Invention

A substantially-cylindrical bottle lid with specially-tailored lid attachments, which together turn a standard bottle into a baby-bottle, said lid comprising: a base and a top, said base being threaded to mate with the threading of the inside wall of a bottle's mouth; and wherein the lid further comprises: an external, substantially central, annular side-ridge [or groove] positioned all the way around the lid's external circumference; a substantially cylindrical hole running vertically through the center of said lid to allow fluid-flow, said hole's diameter being between about 39%-59% that of the lid's total diameter; wherein said lid's top has a top planar region comprising a plurality of dimples wherein nipple base-lugs may fit; said lid top further comprises a lip featuring an inward-facing ridge at the top of said lip; and wherein said lid houses a flanged silicon [or other appropriate plastic or plastic amalgam/composite] nipple, said nipple comprising a spouted-top and a skirt-base, said skirt-base having an upper side and an underside; wherein the skirt's underside further comprises a plurality of protruding lugs; and wherein said nipple-skirt's diameter is marginally-nominally smaller than the lid's diameter, such that said nipple piece fits snugly under the lid's ridged-lip, thereby keeping said nipple flush with the lid's top planar region, while the plurality of nipple-lugs fit into their matching lid-top dimples such that the nipple piece remains secure when the bottle is turned upside-down and fluid is flowing; and wherein, for storage, the nipple may be removed and turned upside down so the spout fits into the lid-center-hole; and a substantially coin-shaped sealing disc of substantially same diameter as the nipple skirt, is fit snugly under the lid's ridged-lip and positioned atop the nipple-skirt's underside, and wherein the resulting lid assembly is then covered by a substantially half-eggshell-shaped cap with side-tabs, such that the cap snaps onto the bottle's lid around the lid's central ridge. The invention wherein said lid further comprises a hinged handle. The invention wherein the lid further comprises a hinged handle, and wherein said eggshell-shaped cap further comprises a loop-and-eye fastener to clip onto said handle when said cap is not in use. The invention wherein the lid further comprises a hinged handle, and wherein said eggshell-shaped cap further comprises a hammerhead-style fastener to clip onto said handle when said cap is not in use. The invention of wherein the lid further comprises a hinged handle, and wherein said eggshell-shaped cap further comprises a plug-and-socket fastener to clip onto said handle when said cap is not in use. The invention of wherein the lid further comprises a hinged handle, and wherein said eggshell-shaped cap further comprises a plug-and-socket fastener to clip onto said handle when said cap is not in use. The invention wherein said lid's top-ridged-lip covers between around 7% to around 27% of the nipple skirt's total area. The invention wherein said nipple spout is a Sippy-Cup style spout utilizing at least one one-way valve and associated surface-tension, to further prevent spillage. The invention of wherein said lid further comprises a thermometric means (aka thermometer) for indicating fluid temperature. The invention further comprising heat-sensitive liquid crystals which turn color upon a threshold acidification, fermentation, culturing or souring of any liquid flowing through the lid's central hole.

### The Instant Disclosure, Generally

In the Summary above and in this Detailed Description, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally

The term “comprises” and grammatical equivalents thereof are used herein to mean that other components, ingredients, steps, etc. are optionally present. An article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range including that number (which may be a range having an upper limit or no upper limit, depending on the variable being defined). For example, “at least 1” means 1 or more than 1. The term “at most” followed by a number is used herein to denote the end of a range, including that number (which may be a range having 1 or 0 as its lower limit, or a range having no lower limit, depending upon the variable being defined). For example, “at most 4” means 4 or less than 4, and “at most 40%” means 40% or less than 40%.

When, in this specification, a range is given as “(a first number) to (a second number)” or “(a first number)−(a second number),” this means a range whose limits include both numbers. For example, “25 to 100” means a range whose lower limit is 25 and upper limit is 100, and includes both 25 and 100.

1. A substantially-cylindrical bottle lid with specially-tailored lid attachments, which together turn a standard bottle into a baby-bottle,
said lid comprising:
a base and a top, said base being threaded to mate with the threading of the inside wall of a bottle's mouth; and
wherein the lid further comprises:
an external annular side-groove positioned around the lid's external circumference;
a substantially cylindrical hole through the center of said lid to allow fluid-flow, said hole having a diameter between about 39%-59% that of the cap's total diameter;
wherein said lid's top has a top planar region comprising a plurality of dimples wherein nipple base-lugs may fit;
said lid further comprising, around the top of its outer circumference, a lip featuring an inward-facing ridge at the top of said lip;
and
wherein said lid houses a flanged silicon nipple piece with a spouted-top and a skirt-base, said skirt-base having an upper side and an underside; wherein the skirt's underside further comprises a plurality of protruding lugs;
and
wherein said skirt's external diameter is marginally-nominally smaller than the lid's diameter, such that said nipple piece fits snugly under the lid's ridged-lip, said skirt thereby remaining flush with the lid's top planar region while the plurality of nipple-lugs fit into the plurality of lid-top's dimples such that the nipple piece remains secure when the bottle is turned upside-down while fluid is flowing through said central-hole;
and wherein, for storage,
the aforementioned nipple may be turned upside down and the nipple spout is fit into the lid's center-hole, and
a substantially coin-shaped sealing disc of substantially same diameter as the nipple skirt, is fit snugly under the lid's ridged-lip and thereby positioned atop the [now upside-down] nipple-skirt;
and wherein the resulting lid assembly is then covered by a substantially half-eggshell-shaped cap with side-tabs, such that said eggshell-shaped cap snaps onto the bottle's lid via the lid's annular groove.

2. The invention of claim 1 wherein said lid further comprises a hinged handle.

3. The invention of claim 1 wherein the lid further comprises a hinged handle, and wherein said eggshell-shaped cap further comprises a loop-and-eye fastener to clip onto said handle to clip onto said handle when said cap is not in use.

4. The invention of claim 1 wherein the lid further comprises a hinged handle, and wherein said eggshell-shaped cap further comprises a hammerhead-style fastener to clip onto said handle to clip onto said handle when said cap is not in use.

5. The invention of claim 1 wherein the lid further comprises a hinged handle, and wherein said eggshell-shaped cap further comprises a plug-and-socket fastener to clip onto said handle to clip onto said handle when said cap is not in use.

7. The invention of claim 1 wherein said lid's top-ridged-lip covers between around 7% to around 27% of the nipple skirt's total area.

8. The invention of claim 1 wherein said nipple spout is a Sippy-Cup style spout utilizing at least one one-way valve and associated surface-tension, to further prevent spillage.

9. The invention of claim 1 wherein said lid further comprises a thermometric means (aka thermometer) for indicating fluid temperature.

10. The invention of claim 1 further comprising heat-sensitive liquid crystals which turn color upon a threshold acidification, fermentation, culturing or souring of any liquid flowing through the lid's central hole.

11. A substantially-cylindrical bottle lid with specially-tailored lid attachments, which together turn a standard bottle into a baby-bottle,
said lid comprising:
a base and a top, said base being threaded to mate with the threading of the inside wall of a bottle's mouth; and
wherein the lid further comprises:
an external, substantially central, annular side-ridge positioned all the way around the lid's external circumference;
a substantially cylindrical hole running vertically through the center of said lid to allow fluid-flow,
said hole's diameter being between about 39%-59% that of the lid's total diameter;
wherein said lid's top has a top planar region comprising a plurality of dimples wherein nipple base-lugs may fit;
said lid top further comprises a lip featuring an inward-facing ridge at the top of said lip;
and
wherein said lid houses a flanged silicon nipple, said nipple comprising a spouted-top and a skirt-base, said skirt-base having an upper side and an underside; wherein the skirt's underside further comprises a plurality of protruding lugs;
and
wherein said nipple-skirt's diameter is marginally-nominally smaller than the lid's diameter, such that said nipple piece fits snugly under the lid's ridged-lip, thereby keeping said nipple flush with the lid's top planar region, while the plurality of nipple-lugs fit into their matching lid-top dimples such that the nipple piece remains secure when the bottle is turned upside-down and fluid is flowing;
and wherein, for storage,
the nipple may be removed and turned upside down so the spout fits into the lid-center-hole; and
a substantially coin-shaped sealing disc of substantially same diameter as the nipple skirt, is fit snugly under the lid's ridged-lip and positioned atop the nipple-skirt's underside,
and wherein the resulting lid assembly is then covered by a substantially half-eggshell-shaped cap with side-tabs, such that the cap snaps onto the bottle's lid around the lid's central ridge.

12. The invention of claim 11 wherein said lid further comprises a hinged handle.

13. The invention of claim 11 wherein the lid further comprises a hinged handle, and wherein said eggshell-shaped cap further comprises a loop-and-eye fastener to clip onto said handle when said cap is not in use.

14. The invention of claim 11 wherein the lid further comprises a hinged handle, and wherein said eggshell-shaped cap further comprises a hammerhead-style fastener to clip onto said handle when said cap is not in use.

15. The invention of claim 11 wherein the lid further comprises a hinged handle, and wherein said eggshell-shaped cap further comprises a plug-and-socket fastener to clip onto said handle when said cap is not in use.

16. The invention of claim 11 wherein the lid further comprises a hinged handle, and wherein said eggshell-shaped cap further comprises a plug-and-socket fastener to clip onto said handle when said cap is not in use.

17. The invention of claim 11 wherein said lid's top-ridged-lip covers between around 7% to around 27% of the nipple skirt's total area.

18. The invention of claim 11 wherein said nipple spout is a Sippy-Cup style spout utilizing at least one one-way valve and associated surface-tension, to further prevent spillage.

19. The invention of claim 11 wherein said lid further comprises a thermometric means (aka thermometer) for indicating fluid temperature.

20. The invention of claim 11 further comprising heat-sensitive liquid crystals which turn color upon a threshold acidification, fermentation, culturing or souring of any liquid flowing through the lid's central hole.
